(19) United States
(12) Patent Application Publication
(10) Pub. No.: US 2022/0013938 A1
(43) Pub. Date: Jan. 13, 2022

(54) FLEXIBLE MULTILAYER ENCAPSULATION OF ELECTRICAL CONNECTIONS

(71) Applicant: IEE INTERNATIONAL ELECTRONICS & ENGINEERING S.A., ECHTERNACH (LU)

(72) Inventors: Matthias MASSING, Konz (DE); Guenter GOEDERT, Trier (DE); Steffen SCHULER, Nittel (DE); Raphaël BENNES, Haute Kontz (FR); Klaus-Peter SCHMITZ, Trier (DE); Harald SCHON, Seinsfeld (DE)

(21) Appl. No.: 17/291,918

(22) PCT Filed: Nov. 6, 2019
(86) PCT No.: PCT/EP2019/080334

§ 371 Date: May 6, 2021

(30) Foreign Application Priority Data
Nov. 7, 2018 (LU) LU100983
Dec. 17, 2018 (LU) LU101059

(51) Int. Cl. H01R 12/63; H01R 12/69; H01R 4/70

(52) U.S. Cl. CPC H01R 12/63; H01R 4/70; H01R 12/69

(57) ABSTRACT

An electrical connection encapsulation device for electrically connecting a flexible flat cable to discrete electrical wires. The device includes a flexible flat cable with a dielectric, planar, flexible carrier and at least one electrically conductive line attached to at least one surface, first and second flat, soft and pliable material layers attached to the first surface and the second surface of the flexible carrier, respectively, by adhesive bonds, at least one electrical connector member that is electrically connectable to a discrete electrical wire at one end and to the at least one electrically conductive line with the other end. The first and second layers are arranged to at least partially overlap the at least one electrically conductive line in the connecting end region in the perpendicular direction, and to extend beyond the end of the at least one electrical connector member that is facing away from the connecting end region.

### TECHNICAL FIELD

The invention relates to an electrical connection encapsulation device for electrically connecting a flexible flat cable to discrete electrical wires, a flexible flat cable-to-electrical wire encapsulated connector device comprising such electrical connection encapsulation device, and a method for producing such flexible flat cable-to-electrical wire encapsulated connector devices.

### BACKGROUND

Electric heating devices are widely used in the automotive industry, for instance for providing passenger comfort by heating a vehicle compartment in general, and/or passenger seats, and/or arm rests, and/or panels, or as a part of a battery temperature management system. Electric heating devices having flexible and/or stretchable heater members are known to be employed in vehicle steering wheels for heating right after start-up of a vehicle engine at cold ambient conditions.

In addition to providing comfort by a fast warming up it is considered as a requirement for such electric heating devices that they should be unnoticeable to the vehicle user if not put into operation.

In the field of automotive vehicle sensor application it is known to employ capacitive sensors for providing input to Automatic Driver Assistance Systems (ADAS), for instance for the purpose of a seat belt reminder (SBR) system or an activation control for an auxiliary restraint system (ARS), based on seat occupation detection and/or classification devices. Sensed signals can serve as a basis for making decisions by an ADAS, for instance for a decision to deploy an air bag system to a specific vehicle seat or not.

Capacitive occupant sensing systems have been proposed in great variety, e.g.

for controlling the deployment of one or more airbags, such as e.g. a driver airbag, a passenger airbag and/or a side airbag.

Another automotive capacitive sensor application is hands-off detection. WO 2016/096815 A1 proposes a planar flexible carrier for use in steering wheel heating and/or sensing. The planar carrier, which can be employed for mounting on a rim of a steering wheel without wrinkles, comprises a portion of planar flexible foil of roughly rectangular shape having two longitudinal sides and two lateral sides. A length B of the lateral sides is 0.96 to 1.00 times the perimeter of the rim. A number of N cut-outs per unit length are provided on each of the longitudinal sides, wherein the cut-outs of one side are located in a staggered fashion relative to opposing cut-out portions on the opposite side. The determining of an optimum shape and size of the cut-outs is described. Further described is a heat carrier, a heating and/or sensing device and methods for their production.

Therefore, it has been proposed in the art to use foil and/or textile as carrier materials for sensor members of sensing devices or for heating members of heating devices in many automotive applications in order to meet available space requirements or to enhance a user comfort. Foil and/or textile-based sensor members and foil and/or textile-based heating members have the appearance of a thin flexible foil or film.

Space and/or user comfort requirements for the sensor member and/or the heater member also hold for the necessary electrical connections to and from the sensor member and/or the heater member. Conventional electrical connections such as crimp connections, clinch connections and riveted connections are often encapsulated, for instance by a hot melt cast process or by a plastic housing with snap fit, which in principle is not adapted to thin flexible foil or film sensor members or heater members. Moreover, hot melt cast processes are time-consuming and require complex manufacturing equipment.

EP 1 061 606 A2 describes a structure for connecting a flat cable to bus bars. To this end, conductor strips are first exposed from the end portion of the flat cable. The structure includes bus bars and conductor strips adhered onto the bus bars, thereby forming a joint section including strip layers and strip gaps. The structure further includes a first and a second insulator resin sheet respectively placed on a first and a second face of the joint section. At least said first insulator resin sheet is then configured such that it penetrates into the strip gaps and adheres onto the second insulator resin sheet, so as to form insulating grooves. In this manner, narrow conductor strips of a flat cable and corresponding bus bars can be connected with sufficient mechanical strengths, and their insulation is improved.

US 2011/0163569 A1 describes a terminal mounting structure and a terminal mounting method therefor. For the terminal mounting structure the electrical continuation and joining strength are sufficiently high although the structure is simple, and further the reliability is high even when it is used over a long period of time. A terminal is connected and continued to a conductor such as a heating wire provided on a substrate. The terminal includes: a fixing portion; elastic portions extending from the fixing portion; and a substrate contact portion provided in the elastic portion so that the substrate contact portion can be protruded with respect to the substrate, and can be electrically connected to the conductor. Each fixing portion is made to adhere to the substrate by a joining means such as a double-sided adhesive tape. The substrate contact portion of the terminal is made to adhere to the substrate by an adhesive under the condition that the substrate contact portion comes into contact with the conductor by a repulsive force generated by an elastic displacement of the elastic portion.

US 2004/0009683 A1 describes an electronic device connecting method, which includes: fixing a sheet-like porous member having a hole to a carrier sheet by pressure sensitive adhesion, the porous member having a photosensitive layer which produces or eliminates an ion exchange group by irradiation with energy beams, on a surface in the hole of the porous member; selectively irradiating a predetermined region of the porous member with energy beams to form a latent image in an irradiated non-irradiated portion the porous member; after irradiating with the energy beams, mounting an electrode of an electronic device closely on the porous member, and peeling the carrier sheet off to transfer the electronic device to the porous member; filling a conductive material in a hole in the latent image of the porous member after the electronic device is transferred; and bonding the porous member after the conductive portion is formed to the electronic device.

DE 20 2015 007 243 U1 describes a connecting element for electronic system components and/or textile materials, in particular textile flat cable. The connecting element comprises a printed circuit board with a top side, a bottom side and a thickness direction, wherein on the top side of the printed circuit board a plurality of contact surfaces is arranged, which are adapted to be electrically connected, by sliding a contacting counterpart in a direction that is orthogonal to the thickness direction, with the contacting counterpart. A plurality of connection points is arranged on the bottom side of the printed circuit board, wherein each connection point is connected by means of a through-connection to one of the contact surfaces and is electrically connected with at least one electronic system component and/or at least one electrical conductor of the textile fabric, in particular of the textile flat cable.

DE 20 2013 002 601 U1 describes a terminal device that comprises a fabric, a first plate, a second plate and a connecting member. The fabric has an electrically conductive thread incorporated therein. The first plate is disposed on a first surface of the fabric and carries a contact conductor on its side facing the first surface of the fabric. The second plate is disposed on a second surface of the fabric opposite the first surface. The connecting member presses the first plate, the fabric and the second plate together in a stack-like arrangement, wherein the conductive thread is arranged across the first surface of the fabric in a region in which the fabric is pressed between the first and the second plate, and is in electrical contact with the contact conductor.

U.S. Pat. No. 7,091,422 B1 describes a flexible flat cable and methods of making and using such a cable. In addition, a vehicle headliner is described that includes a flexible flat cable. The flat cable includes a first insulating layer, a second insulating layer, a first adhesive, a plurality of conductors, a second adhesive, and a first liner. The insulating layers may be made from any polyethylene, polypropylene, polystyrene, polyvinyl chloride, and polyacrylates. The insulating layers may also be made from polyester, polyimide, and polyetheretherketones. Polyimide materials are often used in applications requiring a significant heat history or range of heat parameters because of the heat stability of the polyimides. Some exemplary dielectrics that could be used in the insulating layers include, but are not limited to, polyethylene terephthalate polyester (“PET”), polyethylene naphthalate (“PEN”), polyimide (“PI”), polytetrafluoroethylene (“PTFE”), polyetherimide (“PEI”), polyethersulfone (“PES”), polysulfone (“PSO”), aramid (including commercial embodiments such as Nomex® and Kevlar®), liquid crystal polymer (“LCP”), polyetheretherketone (“PEEK”), polyvinyl fluoride (“PVF”), polyvinylidene fluoride (“PVDF”), Noryl®, polyvinyl chloride (“PVC”), and polyphenylene sulfide (“PPS”).

### SUMMARY

It is therefore an object of the invention to provide an electrical connector for foil and/or textile-based sensor members and heating members that is adapted to the compactness of foil and/or textile-based sensor members and heating members, that provides appropriate mechanical protection against external influences and that allows for using a simple and robust manufacturing process.

In one aspect of the present invention, the object is achieved by an electrical connection encapsulation device for electrically connecting a flexible flat cable to discrete electrical wires.

The electrical connection encapsulation device comprises a flexible flat cable, a first flat, soft and pliable material layer, a second flat, soft and pliable material layer and at least one electrical connector member.

It is noted herewith that the terms “first”, “second”, etc. are used in the present application for distinction purposes only, and are not meant to indicate or anticipate a sequence or a priority in any way.

The flexible flat cable has a connecting end region and includes at least one dielectric, planar, flexible carrier having a first surface and an opposite second surface arranged in parallel to the first surface. At least one out of the first surface and the second surface is equipped with at least one electrically conductive line that is attached to the respective surface and extends at least within the connecting end region.

The first flat, soft and pliable material layer is attached to the first surface of the flexible carrier at the connecting end region by an adhesive bond. The second flat, soft and pliable material layer is attached to the second surface of the flexible carrier at the connecting end region by an adhesive bond.

The at least one electrical connector member is electrically connectable to a discrete electrical wire with one end that is facing away from the connecting end region. The other end of the at least one electrical connector member is facing towards the connecting end region and is arranged to partially overlap the at least one electrically conductive line in a direction that is perpendicular to the surfaces of the flexible carrier for providing an electrical contact to the at least one electrically conductive line at least in an operational state.

The first flat, soft and pliable material layer and the second flat, soft and pliable material layer are arranged to at least partially overlap the at least one electrically conductive line in the connecting end region in the perpendicular direction, and to extend beyond the end of the at least one electrical connector member that is facing away from the connecting end region.

The proposed multi-layer electrical connection encapsulation device can provide a flat, compact design, sufficient reinforcement and mechanical protection against external influences, tightness against liquids and can allow for a use of simple and robust manufacturing techniques. A mechanical reinforcement of electrical connections between conductive lines of a flexible flat cable and discrete electric wires against tensile forces and/or bending loads can readily be established. A mechanical flexibility of encapsulation can be adjusted by a number of layers, respective thickness and type of material.

In principle, the invention is beneficially applicable to any flexible flat cable that needs to be electrically connected to discrete electrical wires or cables. In particular, the invention is applicable with advantage in the automotive sector. The term “automotive”, as used in the present application, shall particularly be understood as being suitable for use in vehicles including passenger cars, trucks, semi-trailer trucks and buses.

Preferably, the electrical connection encapsulation device comprises a protection layer that is arranged to cover and to be in direct contact with a portion of the at least one electrically conductive line in the connecting end region, wherein the protection layer extends beyond the flat, soft and pliable flat material layers in a direction away from the connecting end region. In this way, a further mechanical protection can be provided to the at least one electrically conductive line in an end region of the flat, soft and pliable flat material layers.

In preferred embodiments, the electric connection encapsulation device further comprises at least a first flat, stiff material layer that is attached by an adhesive bond to the first flat, soft and pliable material layer or to the second flat, soft and pliable material layer, to a surface facing away from the flexible carrier. The term “stiff”, as used in the present application, shall in particular be understood such that the stiff material has a bending strength that is at least three times larger, more preferable at least ten times larger, and, most preferable, at least twenty times larger than the bending strength of the flat, soft and pliable material layers. By that, enhanced mechanical protection against external influences can be provided towards at least one side of the electrical connection encapsulation device.

Preferably, the electrical connection encapsulation device additionally includes at least a second flat, stiff material layer that is attached by an adhesive bond to an open surface of the first flat, soft and pliable material layer or the second flat, soft and pliable material layer that is facing away from the flexible carrier. In this way, the first flat, stiff material layer and the second flat, stiff material layer can act together form a protective shell with particularly strong protection properties against mechanical external influences.

Preferably, the first flat, stiff material layer and/or the second flat, stiff material layer are/is made at least for a most part from a material that is selected from a group of materials formed by polyethylene terephthalate (PET), polyimide (PI), polyetherimide (PEI), polyethylene naphthalate (PEN), polyoxymethylene (POM), acrylonitrile butadiene styrene (ABS), polycarbonate (PC), polyether ether ketone (PEEK), metal foil and selected combinations of at least two of these materials.

A mechanical flexibility of encapsulation can be adjusted by a number of layers, respective thickness and type of material.

In preferred embodiments, at least one of the adhesive bonds is provided by a layer of adhesive material. By that, a particularly compact design of the electrical connection encapsulation device can be accomplished.

Preferably, at least one of the adhesive bonds is provided by a double-sided adhesive tape. In this way, the adhesive bond can be prepared in advance, allowing to create a stock, and a fast manufacturing process can be achieved.

In preferred embodiments, an adhesive material of at least one of the adhesive bonds is formed by a pressure-sensitive adhesive. This can allow for a particularly fast manufacturing process.

In preferred embodiments of the electrical connection encapsulation device the flat, soft and pliable material layer, which has a surface that is facing towards the surface of the planar, flexible carrier that is equipped with the at least one electrically conductive line, comprises at least one aperture that is configured for taking up, in an operational state, at least a portion of the at least one electrically conductive line or at least a portion of the at least one electrical connector member.

The phrase “being configured to”, as used in the present application, shall in particular be understood as being specifically laid out, furnished or arranged. The at least one aperture can provide access to the at least one electrically conductive line or to the at least one electrical connector member and can provide installation space for installing bulk electrical components such as resistors and/or capacitors that are electrically connected to the at least one electrically conductive line or to the at least one electrical connector member.

The at least one aperture is adjustable to different flexible flat cables, connecting end regions and electrical connector member geometries and can thus provide a large freedom of design with regard to size, shape and number of apertures for a variety of applications.

Preferably, at least one of the flat, soft and pliable material layers is made at least for a most part from a soft polymeric foam, a synthetic textile or a combination of both.

These materials are available in a large variability, and vast experience exists regarding mechanical properties and production methods. Thus, appropriate materials can be selected from a large pool in order to meet existing application requirements.

As used here and in the claims, the term “synthetic textile” shall particularly be understood to encompass any flexible material consisting of a network of synthetic fibers, e.g. yarns or threads. Yarn may be produced by spinning synthetic fibers to produce long strands. Synthetic textiles may be produced by weaving, knitting, crocheting, knotting, felting, or braiding. Woven textiles are to be understood in particular as a flat fabric comprising at least two interlaced thread systems arranged essentially perpendicular to one another (for instance warp and weft). In this context, a knitted textile or knitted fabric is to be understood in particular to mean a textile produced by interlooping of yarns. The term “synthetic textile” shall also include non-woven fabrics made from intermingled or bonded-together fibers and shall encompass felt, which is neither woven nor knitted.

Non-limiting examples for the soft polymeric foam are expanded polyolefin foams such as expanded polyethylene foam (EPE foam), flexible polyurethane (PUR) foams, or a combination of at least two of these foams.

Preferably, the at least one dielectric, planar, flexible carrier is made at least for a most part from a material that is selected from a group of materials formed by polyethylene terephthalate (PET), polyimide (PI), polyetherimide (PEI), polyethylene naphthalate (PEN), polyether ether ketone (PEEK) and selected combinations of at least two of these materials.

In another aspect of the invention, a flexible flat cable-to-electrical wire encapsulated connector device is provided. The flexible flat cable-to-electrical wire encapsulated connector comprises an electrical connection encapsulation device as disclosed herein, wherein the flexible flat cable comprises a plurality of electrically conductive lines. The flexible flat cable-to-electrical wire encapsulated connector device further includes a plurality of discrete electrical wires. Each of the discrete electrical wires is electrically connected to at least one of the electrical connector members.

The benefits described in context with the electrical connection encapsulation device apply to the flexible flat cable-to-electrical wire encapsulated connector device to the full extent.

In yet another aspect of the invention, a method for producing a flexible flat cable-to-electrical wire encapsulated connector device as disclosed herein is provided. The method comprises at least the following steps:
preparing a first subassembly unit that comprises the flexible flat cable and the plurality of discrete electrical wires being electrically connected to the plurality of electrical connector members,
preparing a second subassembly unit comprising at least the first flat, soft and pliable material layer and a layer of adhesive material or the double-sided adhesive tape,
preparing a third subassembly unit comprising at least the second flat, soft and pliable material layer and a layer of adhesive material or the double-sided adhesive tape,
arranging the subassembly unit on a conveyor unit,
by operating the conveyor unit, transporting the first subassembly unit to a first laminating station,
pressing the first subassembly unit and the second subassembly unit against each other, with the layer of adhesive material or the double-sided adhesive tape facing the plurality of discrete electrical wires, for establishing an adhesive bond,
by operating the conveyor unit, transporting the bonded-together first subassembly unit and second subassembly unit to a second laminating station, and
pressing the bonded-together first subassembly unit and second subassembly unit and the third subassembly unit against each other, with the layer of adhesive material or the double-sided adhesive tape of the third subassembly unit facing the surface of the planar, flexible carrier opposite of the surface with the plurality of discrete electrical wires, for establishing an adhesive bond.

The proposed method can enable a fast, reliable and cost-efficient production of flexible flat cable-to-electrical wire encapsulated connector devices. The method can further provide high flexibility with regard to a bill of materials, and a number of layers can be changed without a need for modification of the manufacturing equipment.

In suitable embodiments, the first, second and third subassembly units can be prepared and held in stock.

Preferably, the conveyor unit comprises a conveyor belt, and in particular a linear conveyor belt. This can allow for a short and hardware-and cost-efficient production line.

In preferred embodiments of the method, the conveyor unit comprises means to provide sufficient reaction force during execution of the steps of pressing. By that, setup times during production of the flexible flat cable-to-electrical wire encapsulated connector devices can be avoided.

These and other aspects of the invention will be apparent from and elucidated with reference to the embodiments described hereinafter.

It shall be pointed out that the features and measures detailed individually in the preceding description can be combined with one another in any technically meaningful manner and show further embodiments of the invention. The description characterizes an embodiment of the invention in particular in connection with the figures.

### BRIEF DESCRIPTION OF THE DRAWINGS

Further details and advantages of the present invention will be apparent from the following detailed description of not limiting embodiments with reference to the attached drawing, wherein:

FIG. 1 schematically illustrates a flexible flat cable-to-electrical wire encapsulated connector device in an operational state, comprising an electrical connection encapsulation device in accordance with an embodiment of the invention, in a perspective view;

FIG. 2 schematically illustrates another embodiment of an electrical connection encapsulation device in accordance with the invention, in a sectional side view;

FIG. 3 schematically shows a setup for executing the method pursuant to FIG. 3;

and

FIG. 4 is a flow chart of a method for producing the flexible flat cable-to-electrical wire encapsulated connector device pursuant to FIG. 2.

### DESCRIPTION OF PREFERRED EMBODIMENTS

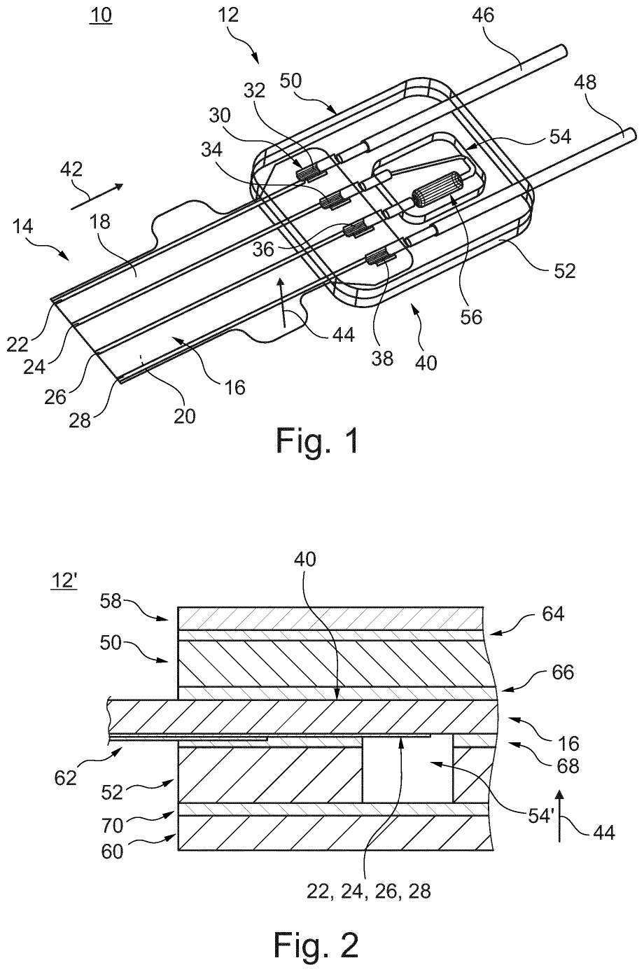

FIG. 1 schematically illustrates a flexible flat cable-to-electrical wire encapsulated connector device 10 in an operational state, comprising an electrical connection encapsulation device 12, in a perspective view.

The electrical connection encapsulation device 12 includes a flexible flat cable 14. The flexible flat cable 14 comprises a dielectric, planar, flexible carrier 16 that has a first surface 18, which is facing upwards in the illustration of FIG. 1, and an opposite second surface 20, which is facing downwards in the illustration of FIG. 1, and is arranged in parallel to the first surface 18.

In this specific embodiment, the dielectric, planar, flexible carrier 16 is completely made from polyetherimide (PEI) and has a thickness of about 75 μm. In other embodiments, the dielectric, planar, flexible carrier may be made at least for a most part from a material that is selected from a group of materials formed by polyethylene terephthalate (PET), polyimide (PI), polyethylene naphthalate (PEN), polyether ether ketone (PEEK) and selected combinations of at least two of these materials. In other embodiments, a thickness of the dielectric, planar, flexible carrier may be selected in a range between 75 μm and 0.35 mm.

The second surface 20 of the flexible flat cable 14 is equipped with a plurality of four electrically conductive lines 22, 24, 26, 28. The four electrically conductive lines 22, 24, 26, 28 are attached to the second surface 20 in a spaced manner and run parallel to a direction of extension 42 of the dielectric, planar, flexible carrier 16. The four electrically conductive lines 22, 24, 26, 28 may be attached to the second surface 20 by applying electrically conductive ink comprising silver or copper in a screen printing or ink jet printing process in combination with a curing process, or, alternatively, by laminating copper foil onto the second surface 20, or by any other method that appears to be suitable to those skilled in the art. A thickness of the four electrically conductive lines 22, 24, 26, 28 in a direction 44 that is perpendicular to the surfaces 18, 20 of the flexible carrier 16 (in the following also referred to as “perpendicular direction 44”) may range between 10 μm and 30 μm and in this specific embodiment is selected to be about 20 μm.

The flexible flat cable 14 comprises a connecting end region 40. The four electrically conductive lines 22, 24, 26, 28 extend to an outer end of the connecting end region 40, where each one of the four electrically conductive lines 22, 24, 26, 28 is ending in a terminal pad 30. The electrical connection encapsulation device 12 further includes a plurality of four electrical connector members 32, 34, 36, 38, which in this specific embodiment are designed as crimp connectors, arranged to partially overlap the electrically conductive lines 22, 24, 26, 28 in the perpendicular direction 44.

The flexible flat cable-to-electrical wire encapsulated connector device 10 further includes a plurality of two discrete electrical wires 46, 48 made from copper. Each of the two discrete electrical wires 46, 48 is electrically connected by crimping to an end of one of the electrical connector members 32, 38 that is facing away from the connecting end region 40. The other ends of the electrical connector members 32, 38 that are facing away from the electrical wires 46, 48 match to the terminal pads and partially overlap the respective electrically conductive line 22, 28 in the perpendicular direction 44. Each of these other ends provide an electrical contact between one of the discrete electrical wires 46, 48 and one of the electrical conductive lines 22, 28 that are arranged close to outer edges of the flexible flat cable 14.

The electrical connection encapsulation device 12 further includes a first flat, soft and pliable material layer 50 of rectangular shape that is attached to the first surface 18 of the flexible carrier 16 at the connecting end region 40 by an adhesive bond. The first flat, soft and pliable material layer 50 is arranged to partially overlap the four electrically conductive lines 22, 24, 26, 28 in the connecting end region 40 in the perpendicular direction 44 and to extend beyond the ends of the four electrical connector members 32, 34, 36, 38 that are facing away from the connecting end region 40, covering a portion of the two discrete electrical wires 46, 48. In this specific embodiment, the adhesive bond is provided by a double-sided adhesive tape. In other embodiments, the adhesive bond may be provided by a layer of adhesive material. In both cases, the adhesive may be formed by a pressure-sensitive adhesive. A thickness of the adhesive bond may range between 50 μm and 1.0 mm. Adhesive bonds provided by a double-sided adhesive tape may tend to be closer to the upper limit, whereas adhesive bonds provided by a layer of adhesive material may tend to be closer to the lower limit.

The electrical connection encapsulation device 12 further comprises a second flat, soft and pliable material layer 52 of rectangular shape that is attached to the second surface 20 of the flexible carrier 16 at the connecting end region 40 by an adhesive bond. The second flat, soft and pliable material layer 52 is arranged to partially overlap the four electrically conductive lines 22, 24, 26, 28 in the connecting end region 40 in the perpendicular direction 44 and to extend beyond the ends of the four electrical connector members 32, 34, 36, 38 that are facing away from the connecting end region 40, covering a portion of the two discrete electrical copper wires 46, 48. In this specific embodiment, the adhesive bond is provided by a double-sided adhesive tape. In other embodiments, the adhesive bond may be provided by a layer of adhesive material. In both cases, the adhesive may be formed by a pressure-sensitive adhesive.

The first 50 and the second flat, soft and pliable material layer 52 have same outer dimensions and are arranged to completely overlap each other in the perpendicular direction 44. In this specific embodiment, they are completely made from a soft polymeric foam, namely expanded polyethylene foam (EPE foam), which is readily commercially available. In other embodiments, though, they may be made, at least for a most part, also from a synthetic textile or from a combination of a soft polymeric foam and a synthetic textile. A thickness of the first flat, soft and pliable material layer 50 and the second flat, soft and pliable material layer 52 in the perpendicular direction 44 may be selected in a range between 0.1 mm and 5.0 mm. The thickness of the first flat, soft and pliable material layer 50 and the thickness of the second flat, soft and pliable material layer 52 may be chosen to be equal, but they may as well be chosen to be different, depending on the specific application.

The second flat, soft and pliable material layer 52, which has a surface that is facing towards the surface 20 of the planar, flexible carrier 16 that is equipped with the plurality of four electrically conductive lines 22, 24, 26, 28, comprises an aperture 54 (or through-hole) that in this specific embodiment is square-shaped, and that is configured for taking up, in the operational state, an end portion of two 34, 36 of the plurality of four electrical connector members 32, 34, 36, 38, which are electrically connected to electrically conductive lines 24, 26 that are arranged in a middle region of a width of the flexible flat cable 14. During a manufacturing process, the aperture 54 provides access to the two 34, 36 of the plurality of four electrical connector members 32, 34, 36, 38 and further provides installation space for installing bulk electrical components such as a resistor 56, as indicated in FIG. 1, which is electrically connected between the two electrical connector members 34, 36 that, in turn, are electrically connected to the electrically conductive lines 24, 26 that are arranged in the middle region of the width of the flexible flat cable 14.

FIG. 2 schematically illustrates an alternative embodiment of an electrical connection encapsulation device 12′, in a sectional side view. In order to avoid unnecessary repetitions, only differences with respect to the first embodiment pursuant to FIG. 1 will be described. For features in FIG. 2 that are not described in context with the alternative embodiment, reference is made to the description of the first embodiment.

In comparison to the embodiment shown in FIG. 1, the electrical connection encapsulation device 12′ pursuant to FIG. 2 further comprises a first flat, stiff material layer 58 that is attached by an adhesive bond to a surface of the first flat, soft and pliable material layer 50 that is facing away from the flexible carrier 16. The electrical connection encapsulation device 12′ also includes a second flat, stiff material layer 60 that is attached by an adhesive bond to an open surface of the second flat, soft and pliable material layer 52 that is facing away from the flexible carrier 16.

In this specific embodiment, the first flat, stiff material layer 58 and the second flat, stiff material layer 60 are completely made from polyethylene terephthalate (PET). In other embodiments, the first flat, stiff material layer and the second flat, stiff material layer may be made, at least for a most part, from a material that is selected from a group of materials formed by polyimide (PI), polyetherimide (PEI), polyethylene naphthalate (PEN), polyoxymethylene (POM), acrylonitrile butadiene styrene (ABS), polycarbonate (PC), polyether ether ketone (PEEK), metal foil and selected combinations of at least two of these materials.

A thickness of the first flat, stiff material layer 58 and the second flat, stiff material layer 60 in the perpendicular direction 44 may be selected in a range between 10 μm and 3.0 mm. The thickness of the first flat, stiff material layer 58 and the thickness of the second flat, stiff material layer 60 may be chosen to be equal, but they may as well be chosen to be different, as indicated in FIG. 2, depending on the specific application.

The electrical connection encapsulation device 12′ comprises a dielectric protection layer 62 that is arranged to cover and to be in direct contact with a portion of the plurality of four electrically conductive lines 22, 24, 26, 28 in the connecting end region 40. The dielectric protection layer 62 extends beyond the first flat, soft and pliable material layer 50 and the second flat, soft and pliable material layer 52 in a direction away from the connecting end region 40. The dielectric protection layer 62 may be made for a most part or completely from polyurethane or any other material that appears to be suitable to those skilled in the art. A thickness of the dielectric protection layer 62 in the perpendicular direction 44 may be selected in a range between 10 μm and 80 μm.

The aperture 54 in the second flat, soft and pliable material layer 52 in this specific embodiment is arranged for taking up, in the operational state, end portions of the plurality of four electrically conductive lines 22, 24, 26, 28.

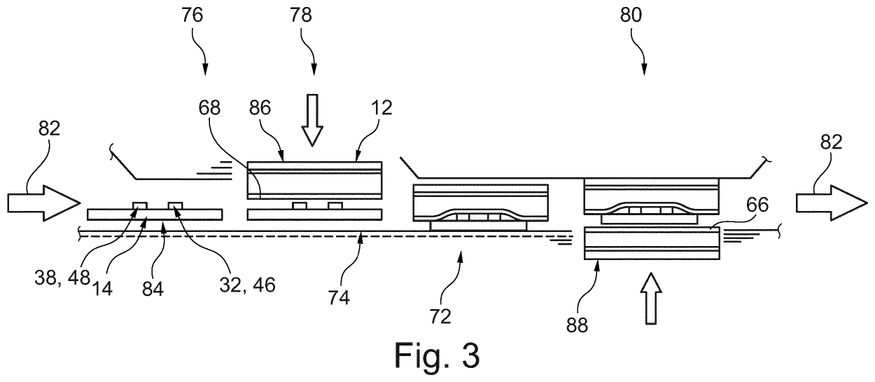

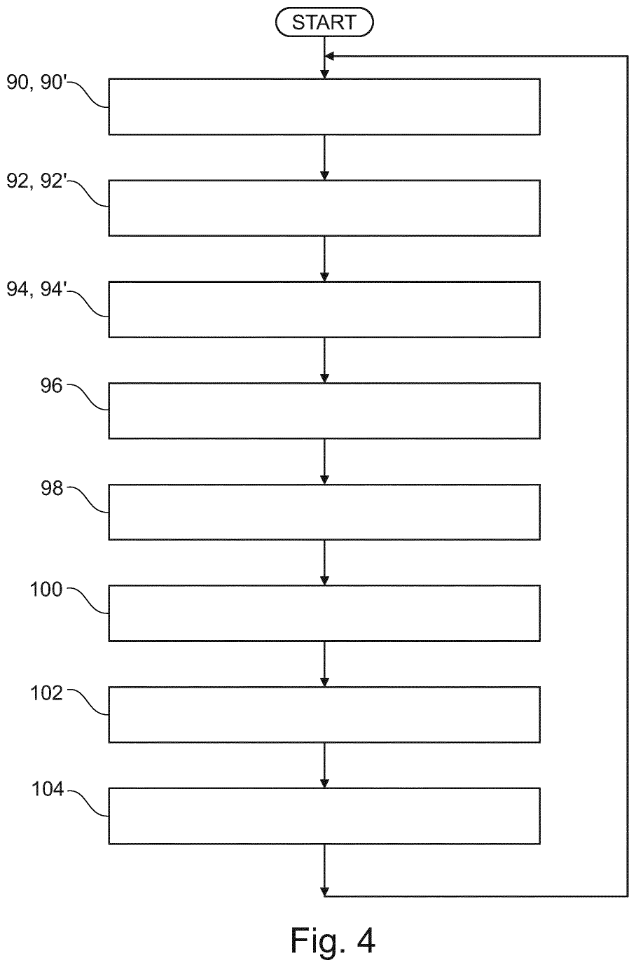

In the following, a method for producing a flexible flat cable-to-electrical wire encapsulated connector device with the electrical connection encapsulation device 12′ pursuant to FIG. 2 will be described with reference to FIGS. 2, 3 and 4, which schematically show a production setup in FIG. 3 for executing the method as show in a flow chart in FIG. 4.

The production setup includes a conveyor unit 72 comprising a linear conveyor belt 74 and a controllable electric drive (not shown) for driving the conveyor belt 74. The setup further comprises a pick and place station 76, a first laminating station 78 and a second laminating station 80. The linear conveyor belt 74 is configured to move items to at least these three stations 76, 78, 80 along one conveying direction 82. At the first laminating station 78 and at the second laminating station 80 the production setup further comprises a pressure stamp (not shown) for applying a mechanical load from above or from below, respectively, and also a sufficiently rigid platform (not shown) that is extendable during stops of the linear conveyor belt 74 to provide sufficient reaction force against a mechanical load applied by the respective pressure stamp.

A first subassembly unit 84 that comprises the flexible flat cable 14 and the plurality of two discrete electrical copper wires 46, 48 that are electrically connected to the plurality of two electrical connector members 32, 38 is prepared in a preparatory step 90. As an alternative step 90′, a plurality of first subassembly units 84 can also be prepared in advance, held in stock and procured for production.

As a second subassembly unit 86, a sandwiched assembly of the second flat, stiff material layer 60, a double-sided adhesive tape 70, the second flat, soft and pliable material layer 52, and another double-sided adhesive tape 68 is prepared in a preparatory step 92. As an alternative step 92′, a plurality of second subassembly units 86 can also be prepared in advance, held in stock and procured for production.

As a third subassembly unit 88, a sandwiched assembly of a double-sided adhesive tape 66, the first flat, soft and pliable material layer 50, another double-sided adhesive tape 64 and the first flat, stiff material layer 58 is prepared in a preparatory step 94. As an alternative step 94′, a plurality of third subassembly units 88 can also be prepared in advance, held in stock and procured for production.

In a next step 96 of the method, the first subassembly unit 84 is arranged at the pick and place station 76. By operating the conveyor unit 72, the first subassembly unit 84 is transported to the first laminating station 78 in another step 98. There, the first subassembly unit 84 and the second subassembly unit 86 are pressed against each other in a next step 100, with the double-sided adhesive tape 68 facing the plurality of discrete electrical wires 46, 48, for establishing an adhesive bond by operating the pressure stamp to apply a predetermined mechanical load from above and by extending a sufficiently rigid platform from below.

By operating the conveyor unit 72 in a next step 102, the bonded-together first 84 and second subassembly unit 86 are transported to the second laminating station 80. There, the bonded-together first 84 and second subassembly unit 86 and the third subassembly unit 88 are pressed against each other in a next step 104, with the double-sided adhesive tape 66 of the third subassembly unit 88 facing the surface 18 of the planar, flexible carrier 16 opposite of the surface 20 with the plurality of discrete electrical wires 46, 48, for establishing an adhesive bond by operating the pressure stamp to apply a predetermined mechanical load from below and by extending a sufficiently rigid platform from above.

While the invention has been illustrated and described in detail in the drawings and foregoing description, such illustration and description are to be considered illustrative or exemplary and not restrictive; the invention is not limited to the disclosed embodiments.

Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality, which is meant to express a quantity of at least two. The mere fact that certain measures are recited in mutually different dependent claims does not indicate that a combination of these measures cannot be used to advantage. Any reference signs in the claims should not be construed as limiting scope.

1. An electrical connection encapsulation device for electrically connecting a flexible flat cable to discrete electrical wires, comprising:
a flexible flat cable having a connecting end region and including at least one dielectric, planar, flexible carrier having a first surface and an opposite second surface arranged in parallel to the first surface, wherein at least one out of the first surface and the second surface is equipped with at least one electrically conductive line, being attached to the respective surface and extending at least within the connecting end region,
a first flat, soft and pliable material layer that is attached to the first surface of the flexible carrier at the connecting end region by an adhesive bond,
a second flat, soft and pliable material layer that is attached to the second surface of the flexible carrier at the connecting end region by an adhesive bond,
at least one electrical connector member that is electrically connectable to a discrete electrical wire with one end facing away from the connecting end region, and whose other end is facing towards the connecting end region and is arranged to partially overlap the at least one electrically conductive line in a direction that is perpendicular to the surfaces of the flexible carrier for providing an electrical contact to the at least one electrically conductive line at least in an operational state,
wherein the first flat, soft and pliable material layer and the second flat, soft and pliable material layer are arranged to at least partially overlap the at least one electrically conductive line in the connecting end region in the perpendicular direction, and to extend beyond the end of the at least one electrical connector member that is facing away from the connecting end region.

2. The electrical connection encapsulation device as claimed in claim 1, further comprising at least a first flat, stiff material layer that is attached by an adhesive bond to the first flat, soft and pliable material layer or to the second flat, soft and pliable material layer, to a surface facing away from the flexible carrier.

3. The electrical connection encapsulation device as claimed in claim 2, further comprising at least a second flat, stiff material layer that is attached by an adhesive bond to an open surface of the first flat, soft and pliable material layer or the second flat, soft and pliable material layer that is facing away from the flexible carrier.

4. The electrical connection encapsulation device as claimed in claim 1, wherein at least one of the adhesive bonds is provided by a layer of adhesive material.

5. The electrical connection encapsulation device as claimed in claim 1, wherein at least one of the adhesive bonds is provided by a double-sided adhesive tape

6. The electrical connection encapsulation device as claimed in claim 1, wherein an adhesive material of at least one of the adhesive bonds is formed by a pressure-sensitive adhesive.

7. The electrical connection encapsulation device as claimed in claim 1, wherein the second flat, soft and pliable material layer, which has a surface that is facing towards the surface of the planar, flexible carrier that is equipped with the at least one electrically conductive line, comprises at least one aperture that is configured for taking up, in an operational state, at least a portion of the at least one electrically conductive line or at least a portion of the at least one electrical connector member.

8. The electrical connection encapsulation device as claimed in claim 1, wherein at least one of the flat, soft and pliable material layers is made at least for a most part from a soft polymeric foam, a synthetic textile or a combination of both.

9. The electrical connection encapsulation device as claimed in claim 1, wherein the at least one dielectric, planar, flexible carrier is made at least for a most part from a material that is selected from a group of materials formed by polyethylene terephthalate, polyimide, polyetherimide, polyethylene naphthalate, polyether ether ketone and selected combinations of at least two of these materials.

10. A flexible flat cable-to-electrical wire encapsulated connector device, comprising an electrical connection encapsulation device as claimed in claim 1, the flexible flat cable having a plurality of electrically conductive lines, the flexible flat cable-to-electrical wire encapsulated connector device further including a plurality of discrete electrical wires, wherein each of the discrete electrical wires is electrically connected to at least one of the electrical connector members.

11. A method for producing a flexible flat cable-to-electrical wire encapsulated connector device as claimed in claim 10, the method comprising at least the following steps:
preparing a first subassembly unit that comprises the flexible flat cable and the plurality of discrete electrical wires being electrically connected to the plurality of electrical connector members,
preparing a second subassembly unit comprising at least the second flat, soft and pliable material layer and a layer of adhesive material or the double-sided adhesive tape,
preparing a third subassembly unit comprising at least the first flat, soft and pliable material layer and a layer of adhesive material or the double-sided adhesive tape,
arranging the first subassembly unit on a conveyor unit,
by operating the conveyor unit, transporting the first subassembly unit to a first laminating station ,
pressing the first subassembly unit and the second subassembly unit against each other, with the layer of adhesive material or the double-sided adhesive tape facing the plurality of discrete electrical wires, for establishing an adhesive bond,
by operating the conveyor unit, transporting the bonded-together first subassembly unit and second subassembly unit to a second laminating station, and
pressing the bonded-together first subassembly unit and second subassembly unit and the third subassembly unit against each other, with the layer of adhesive material or the double-sided adhesive tape of the third subassembly unit facing the surface of the planar, flexible carrier opposite of the surface with the plurality of discrete electrical wires, for establishing an adhesive bond.

12. The method as claimed in claim 11, wherein the conveyor unit comprises means to provide sufficient reaction force during execution of the steps of pressing.
